(19) United States
(12) Patent Application Publication
(10) Pub. No.: US 2013/0342985 A1
(43) Pub. Date: Dec. 26, 2013

(54) COMPUTING DEVICE PROTECTOR

(71) Applicants: David Santos, Garnite Bay, CA (US); Robert Todd Wells, Rocklin, CA (US)

(72) Inventors: David Santos, Garnite Bay, CA (US); Robert Todd Wells, Rocklin, CA (US)

(21) Appl. No.: 14/003,510

(22) PCT Filed: May 6, 2011
(86) PCT No.: PCT/US2011/035648

§ 371 Date: Sep. 6, 2013

(51) Int. Cl. H02G 3/08; G06F 1/16

(52) U.S. Cl. CPC H02G 3/081; G06F 1/16
USPC 361/679.02; 174/66

(57) ABSTRACT

A computing device protector. A faceplate to limit access to an exposed surface of a computing device. The exposed surface of the computing device comprises control features and the faceplate is configured limit access to only a portion of the control features. The faceplate is configured to be positioned relative to the computing device such that the faceplate can be removed without requiring the computing device to be dismounted.

### FIELD

Embodiments of the present invention relate generally to protectors limiting access to a computing device.

### BACKGROUND

Modern computing devices include devices such as a network switch or router. Computing devices are often located in a public facility where a person may have physical access to the computing device. An unauthorized person may attempt to control the computing device by pressing buttons, removing or adding cables, etc. Such unauthorized control may cause undesirable performance related to the intended use of the computing device.

### BRIEF DESCRIPTION OF THE DRAWINGS

FIG. 1 illustrates a perspective view of a block diagram of a computing device protector in accordance with embodiments of the present technology.

FIG. 2 illustrates a front view of a block diagram of a computing device protector in accordance with embodiments of the present technology.

FIG. 3 illustrates a cross-section top view of a block diagram of a computing device protector in accordance with embodiments of the present technology.

FIG. 4 illustrates a perspective view of a block diagram of a computing device protector in accordance with embodiments of the present technology.

The drawings referred to in this description of embodiments should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

The computer system, network device, or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### Overview of Discussion

Embodiments of the present technology are for computer device protectors used to limit access to a computer device.

Computing devices are varied and may include a device such as a network switch. Such a device may be placed in a public place or area for convenience, necessity or other reasons. Public places may include schools, classrooms, libraries, conference rooms, hotels, lobbies, etc. When the device is placed in a public area the device may be in physical proximity to different types of people. People in proximity to the device may or may not be users of the device and may need to interface with the device in a limited way. System administrators may need full access to the device for maintenance, repairs, updates, changes in configuration, etc. Some members of the public may attempt unauthorized control of the device which can lead to undesirable performance of the device or use of the device in an unintended manner. Thus it is useful to limit access to the device when it comes to members of the general public while making it convenient for a system administrator to have full authorized access to the device.

In the public area, the computing device may be mounted to a structure such as a rack, a desk, a wall, etc. In one embodiment, while mounted, the computing device may expose only one surface of the computing device that has control features.

Embodiments of the present technology provided limited access to a computing device to members of the general public while providing convenient full access to a system administrator. In one embodiment, the present technology is a computing device protector which comprises a faceplate that limits access to the computing device. For example, the faceplate may be made of a solid material that is not easily bent or broken and is designed in a shape that will allow access to some control features of the computing device and prevent access to other control features while the faceplate is in place. In one embodiment, the faceplate is secured to two mounting brackets via fasteners. The mounting brackets are secured to the computing device and may be located between the structure and the computing device. The faceplate is secured to the mounting brackets using a tamper-resistant-fastener. In one embodiment, a tamper-resistant-fastener requires a special tool to turn or drive the fastener.

In one embodiment, there is an opening formed through the faceplate that allows a cable to pass through the opening because the dimensions of the opening are sufficiently large to allow the cable to pass through. Additionally, the opening is sufficiently small such that a cable connector attached to an end of the cable cannot pass through the opening. In one embodiment, a cable may pass through the described opening in the faceplate, but cannot be removed from the computing device once the faceplate is coupled to the computing device. For example, the cable may be an Ethernet cable that extends through an opening or slot in the faceplate. Before the faceplate is mounted relative to the computing device, the connector on the end of the Ethernet cable is inserted into a port on the computing device. When the faceplate is mounted relative to the computing device, tabs associated with the faceplate enclose the connector in an area such that the connector on the end of the Ethernet cable cannot pass through the opening in the faceplate and thus the cable cannot be removed relative to the faceplate and the computing device. Additionally, once the faceplate is mounted relative to the computing device, it is extremely difficult to remove the cable connector from the port on computing device.

In one embodiment, a system administrator or other authorized user is provided with the tool for the tamper-resistant-fastener that allows the system administrator to remove the face plate. The faceplate may be removed from its position relative to the computing device without requiring the computing device to be dismounted. The faceplate may also be removed without requiring the mounting brackets to be dismounted or unfastened from the computing device or the structure. These features save the system administrator time and effort in gaining access to control features of a computing device using such a faceplate.

In one embodiment, the face plate allows general users or other people in the public place to view indicator lights and displays that may be required for the general user to effectively use the computing device to the extent that they are authorized to use the computing device. Thus the present technology provides mechanical protection for a computing device when it comes to general users while making it convenient for a system administrator to have full authorized access to the device.

The following discussion will demonstrate various hardware and other components that are used with and in computing device, network devices and computer systems used for a computing device protector in various embodiments of the present technology. Furthermore, embodiments of computing device protectors may include some, all, or none of the components discussed below.

### Embodiments of Computing Device Protectors

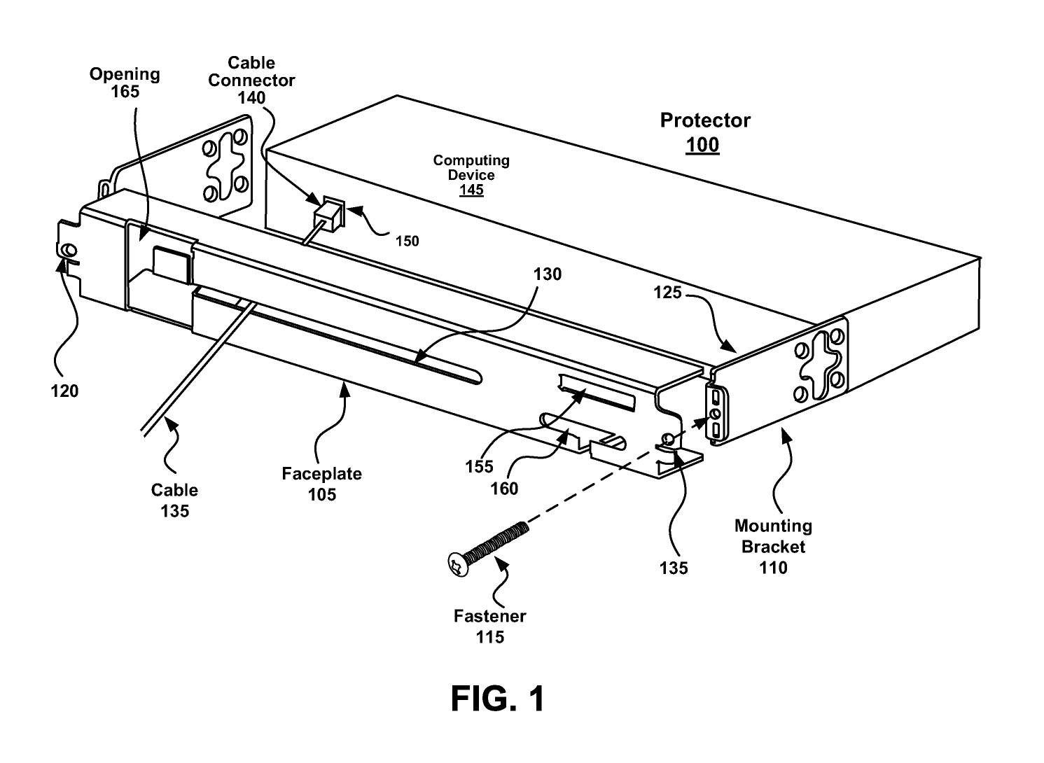

With reference now to FIG. 1, a block diagram of a perspective view of a computing device protector. Protector 100 includes faceplate 105, mounting bracket 110, fastener 115, cable 135, cable connector 140, computing device 145, port 150, and openings 120, 125, 130, 155, 160 and 165. Protector 100 should not be construed to limit the present technology.

Protector 100 depicts faceplate 105 with a particular design that may or may not be drawn to scale for various embodiments. In one embodiment, faceplate 105 is designed to limit access to a computing device such as computing device 145. Faceplate 105 is constructed of a material that is not easily bent, broken or flexed. For example, faceplate 105 may be constructed of steel, steel alloy, metal, aluminum, plastic, composites, etc. In one embodiment, faceplate 105 is constructed of a plurality of different materials.

In one embodiment, faceplate 105 limits access to an exposed surface of a computing device by being fixed in position relative to the computing device. In one embodiment, the computing device is mounted in a structure in such a manner that a surface of the computing device is exposed to a public area. The computing device may have control features on the exposed surface. In one embodiment, faceplate 105 is configured to limit access to the exposed surface of the computing device and to limit access to the control features of the computing device on the exposed surface. In one embodiment, faceplate 105 limits access to only one surface of the computing device.

In one embodiment, the computing device has control features which allow for the control of the computing device which includes, configuring the computing device, toggling switches, pressing buttons, coupling hardware components with the computing device, etc. It should be appreciated that control features of the computing device may include, but are not limited to, a port, a transceiver, an indicator light, a media access control (MAC) address display, a serial number display, a status indicator, an Ethernet port, a small form factor pluggable (SFP) port, an indicator, a cable, a switch, a dongle and a button.

In one embodiment, faceplate 105 is designed such that it may be employed with more than one type or model of computing devices. For example, faceplate 105 may be designed to work with three network switches where all three network switches belong to the same family of models. Some features of faceplate 105 may not have a purpose when used with a particular model, but overall faceplate 105 would still be useful for purposes of the present technology.

In one embodiment, faceplate 105 is mounted directly to the computing device. In one embodiment, faceplate 105 is not mounted directly to the computing device. In one embodiment, the computing device protector includes mounting bracket 110. Mounting bracket 110 is mounted to the computing device and is configured to receive and mount faceplate 105. In one embodiment, the computing device protector includes two mounting brackets 110 that may or may not be identical to one another. Mounting bracket 110 may be constructed of material similar to that of faceplate 105.

In one embodiment, mounting bracket 110 is secured to a structure, the computing device and faceplate 105. In one embodiment, mounting bracket 110 comprises openings 125. FIG. 1 depicts opening 125 to include four holes as well as a cross shaped cut-out. Openings 125 may be placed in such a manner that they are compatible with standard sized openings on a computing device. For example, a computing device may be a standard 1U rack mountable size and have openings on the side designed to receive fasteners to mount in a standard structure or rack designed to receive a standard size 1U computing device. Thus mounting bracket 110 may be designed to fit a variety of computing devices. Thus the present technology may be practiced using more than one type of faceplate or computing device with the same design of mounting bracket. In one embodiment, openings 125 of mounting bracket 110 may be customized to fit a particular computing device.

In one embodiment, mounting bracket 110 is designed to fit in between a standard rack and the computing device. Thus the same fastener used to mount the computing device to the rack may be employed to secure mounting bracket 110 to the computing device. In one embodiment, faceplate 105 does not mount or attach direct to the computing device but instead is coupled to the computing device via mounting bracket 110. Thus faceplate 105 may be fixed in position relative to the computing device without requiring faceplate 105 to be attached directly to the computing device. Mounting bracket 110 may be described as an ear. In an embodiment where two mounting brackets are employed, they may be described as a left ear and a right ear.

In one embodiment, faceplate 105 is attached to mounting bracket 110 via fastener 115. Fastener 115 is depicted in FIG. 1 as being a Philips head screw or bolt. It should be appreciated that fastener 115 is not limited to a Philips head screw or bolt. Fastener 115 may be a tamper-resistant-fastener, a screw, a mechanical lock, a hinge, a bolt or some other type of well known fastener. Fastener 115 may be designed so it is difficult to remove without proper tools. Fastener 115 may be designed to be removed with standard tools or without tools. In one embodiment, fastener 115 is not required to be removed from faceplate 105 in order to be remove faceplate 105 from the computing device. A mechanical lock that requires a key is an example of this embodiment.

In one embodiment, fastener 115 is a tamper-resistant-fastener such as a screw with a head slot or pin of a unique design that requires a matching key or tool to turn and drive the screw. Thus a system administrator or other authorized user may employ the key or tool to quickly remove the fastener, but it would be more difficult for a general user to remove the fastener without the key or tool which would be less-common for a general user to obtain. It should be appreciated that more than one fastener may be used to secure faceplate 105 to a single mounting bracket 110. In one embodiment, faceplate 105 is directly attached to two mounting brackets. Faceplate 105 depicts an opening, opening 135, through which fastener 115 is inserted through faceplate 105 as well as opening 120 which is a second opening in faceplate 105 that allows a mounting bracket to be attached to faceplate 105 with a second fastener.

With the use of fastener 115 and mounting bracket 110, faceplate 105 may be removed from the computing device without requiring the computing device to be dismounted or removed from its fixed position. Additionally mounting bracket 110 is not required to be removed from the computing device for faceplate 105 to be removed. Thus a system administrator could remove faceplate 105 in a time saving manner relative to a protector that requires the computing device to be removed or dismounted from its fixed position in order to remove the protector.

FIG. 1 depicts faceplate 105 as having openings 130, 155, 160 and 165. In one embodiment, openings 130, 155, 160 and 165 provide access to control features of the computing device. For example, faceplate 105 may provide limited access to a display through opening 130, 155, 160 and 165 such that a user could read the display, but would deny access to a switch or button behind a solid portion of faceplate 105.

In one embodiment, faceplate 105 has opening disposed therein that secure a cable such that the cable cannot be removed relative to faceplate 105 once faceplate 105 has been mounted relative to computing device 145. In one embodiment, such an opening is opening 130 of faceplate 105. For example, cable 135 may comprise cable connector 140 located at one end of cable 135 where the thickness of cable connecter 140 is thicker than the thickness of cable 135. Opening 130 may be sufficiently large enough to allow the thickness of cable 135 to pass through, but sufficiently small enough such that cable connector 140 cannot pass through opening 130.

In one embodiment, before faceplate 105 is mounted relative to computing device 145, cable 135 and cable connector 140 are passed through opening 165 which is large enough to allow both to pass through. Cable 135 is then passed through opening 130. Once faceplate 105 is mounted relative to computing device 145, cable connector 140 is no longer able to pass through an opening in faceplate 105 including opening 165. This is accomplished by forming tabs and slots in faceplate 105 such that once faceplate 105 is mounted relative to computing device 145 an enclosed area is formed between computing device 145 and faceplate 105 such that there are no openings sufficiently large enough for cable connector 140 to pass through.

In one embodiment, cable connector 140 is inserted into port 150 of computing device 145 before faceplate 105 is mounted relative to computing device 145. Once faceplate 105 is mounted relative to computing device 145, it is extremely difficult, if not impossible, to remove cable connector 140 from port 150. Once faceplate 105 is mounted relative to computing device 145, cable 135 will continue to extend through opening 130. It should be appreciated that cable 135 may shift or slide within opening 130, but once faceplate 105 is mounted relative to computing device 145, cable 135 cannot be complete removed from faceplate 105 nor computing device 145 because cable connector 140 cannot pass through an opening sufficiently large enough to allow for the thickness of cable connector 140.

In one embodiment, faceplate 105 has more than one opening similar to opening 130 that allow for a cable to pass through the opening but not the cable connector. In one embodiment, faceplate 105 has different size openings that accommodate different sizes of cables and cable connectors such that the cable may not be removed from faceplate 105 after faceplate 105 is mounted relative to computing device 145. In one embodiment, opening 160 allows a cable to pass through and does not require an opening equivalent to opening 165 for opening 130. This is accomplished because opening 160 includes a slot in faceplate 105 that is open on one end. Thus a cable may be fitted or passed through the slot of opening 160 with the cable connector appropriately oriented to be inserted into computing device 145.

It should be appreciated that cable 135 may be a variety of standard cables including network cables, Ethernet cables, category 5 (Cat 5) cables, phone cable, twisted pair cable, etc. with cable connector 140 being a standard connector associated with such cables.

The present technology thus allows a cable to be connected to computing device 145 in a secure manner such that is difficult, if not impossible, to remove the cable relative to computing device 145 without first removing faceplate 105. Thus computing device 145 may be placed in a public area with cables connected to computing device 145 with substantially decreased risk of a member of the public tampering with or removing the cable. Such a cable may be connected to computing device 145 at one end and connected to another device at the other end, or may be free floating and available for members of the public to attach a device to the free floating end of the cable.

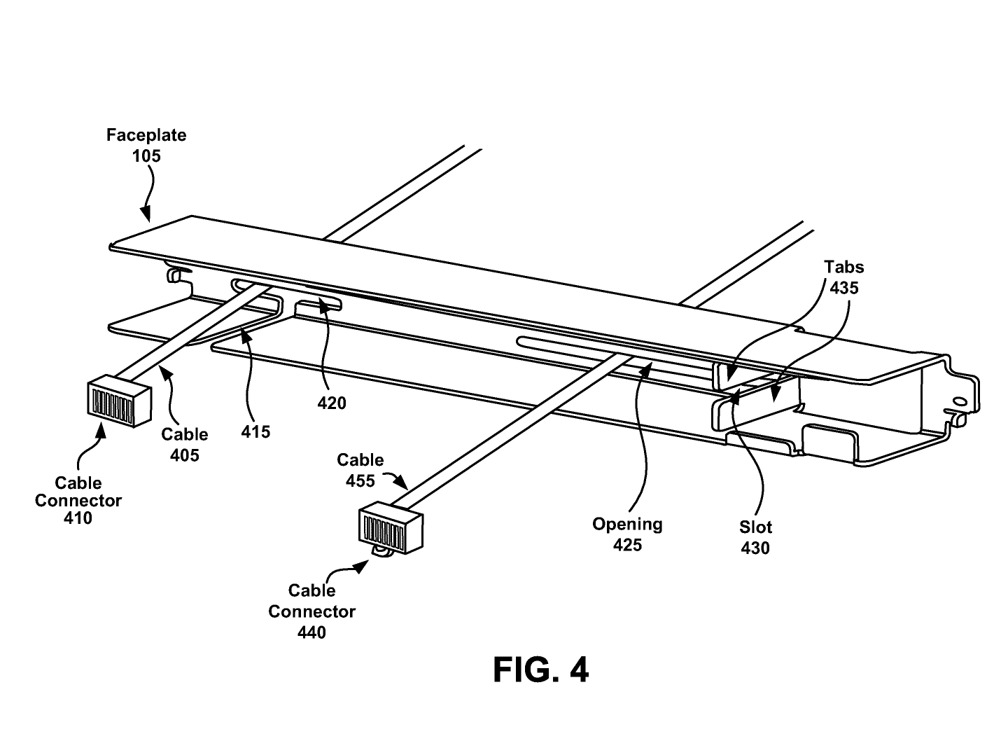

With reference now to FIG. 4, a block diagram of a rear view of a computing device protector. FIG. 4 includes faceplate 105, cables 405 and 435, cable connectors 410 and 440, slots 415 and 430, openings 420, 425 and 445, and tabs 450. FIG. 4 should not be construed to limit the present technology.

It should be appreciated that faceplate 105 of FIG. 4 has all the same features and capabilities as those described for faceplate 105 of FIG. 1. FIG. 4 depicts cable 405 passed through opening 420. Opening 420 is a rear view of opening 160 of FIG. 1. In one embodiment, before faceplate 105 is mounted to computing device 145, cable 405 is extended along and inserted into slot 415. Slot 415 is connected to opening 420 such that cable 405 may pass through slot 415 and into opening 420. In one embodiment, the dimensions of slot 415 and opening 420 are sufficiently large to allow cable 405 to pass through, but sufficiently small such that cable connector 410 cannot pass through either slot 415 and opening 420. After cable 405 is inserted into opening 420, cable connector 410 may then be inserted into a port of computing device 145. Then faceplate 105 may be coupled with computing device 145. In one embodiment, faceplate 105 forms an enclosed area with computing device 145 and a mounting bracket such that there is not an opening sufficiently large for cable connector 410 to pass through. For example, the open end of slot 415 is placed close enough to computing device 145 such that there is not a gap or space large enough for cable connector 410 to pass through. Thus cable connector 410 is trapped or secured in the enclosed area and cannot be removed without uncoupling faceplate 105 from computing device 145.

In one embodiment, opening 425 is the rear side of opening 130 of FIG. 1 and is connected to opening 445 which is the rear side of opening 165 of FIG. 1. In one embodiment, faceplate 105 is also formed with tabs 435 forming slot 430. Slot 430 is open on one end and connected with opening 425 on the opposite end. In one embodiment, before faceplate 105 is mounted to computing device 145, cable 435 is extended through opening 445 and then extended along and inserted into slot 430. Cable 435 is then inserted into opening 425. In one embodiment, the dimensions of slot 430 and opening 425 are sufficiently large to allow cable 435 to pass through, but sufficiently small such that cable connector 410 cannot pass through either slot 430 or opening 425. After cable 435 is inserted into opening 425, cable connector 440 may then be inserted into a port of computing device 145. Then faceplate 105 may be coupled with computing device 145. In one embodiment, faceplate 105 forms an enclosed area with computing device 145 and tabs 435 such that there is not an opening sufficiently large for cable connector 440 to pass through. For example, the open end of slot 430 is placed close enough to computing device 145 such that there is not a gap or space large enough for cable connector 440 to pass through. Thus cable connector 440 is trapped or secured in the enclosed area and cannot be removed without uncoupling faceplate 105 from computing device 145.

It should be appreciated that cables 435 and 405 may shift or move slightly within openings 420 and 425 once faceplate 105 is coupled with computing device 145. However, cables 405 and 435 may not be completely removed from faceplate 105 nor computing device 145 once faceplate 105 is coupled with computing device 145 without damaging the cables, faceplate 105 or computing device 145.

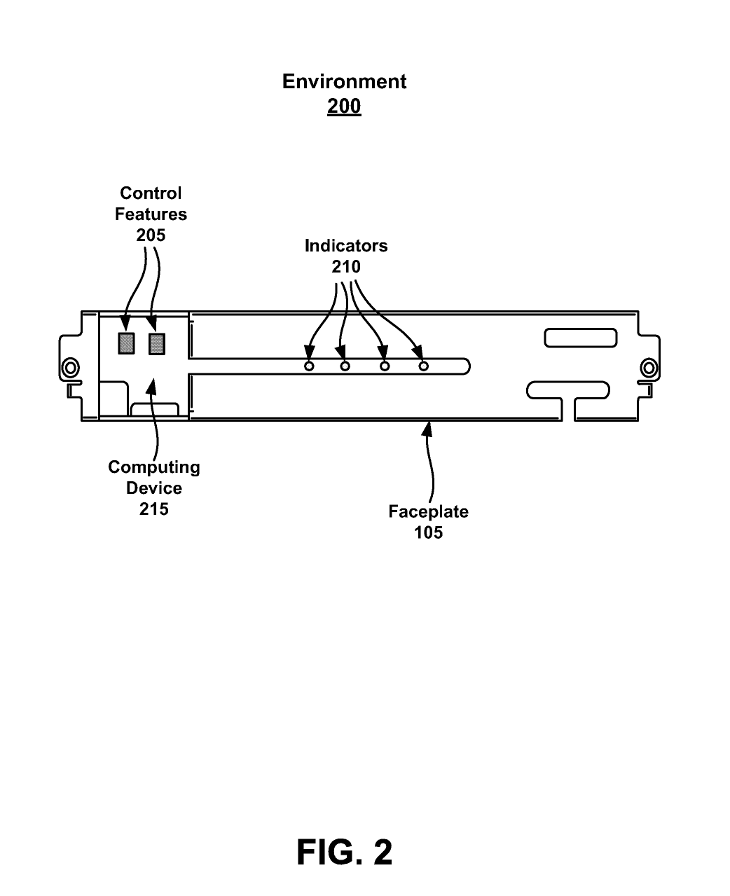

With reference now to FIG. 2, a block diagram of a front view of a computing device protector. Environment 200 includes faceplate 105, control features 205, indicators 210, and computing device 215. Environment 200 should not be construed to limit the present technology.

It should be appreciated that faceplate 105 of FIG. 2 has all the same features and capabilities as those described for faceplate 105 of FIG. 1. FIG. 2 depicts the front view of faceplate 105 and exposed portions of computing device 215. It should be appreciated that computing device 215 may be, but is not limited to, a network switch, a router, a computer system, or the like. In one embodiment, computing device 215 has a surface that comprises control features that allow a user to operate, configure, update, connect to, receive information from, or otherwise control computing device 215. In one embodiment, control features of computing device 215 may include a port, an indicator light, a MAC address display, a serial number display, a status indicator, an Ethernet port, an SFP port, an indicator, a cable, a switch, a dongle and a button.

In one embodiment, computing device 215 is mounted or otherwise fixed in a position that only one surface of computing device 215 that has control features is exposed. The present technology may be employed regardless of how many surfaces of computing device 215 are exposed. In one embodiment, faceplate 105 is designed to be indirectly coupled to computing device 215 in a manner that allows access to some control features of computing device 215 and prevents access to other control features of computing device 215. The present technology may be configured using a variety of designs to allow for many configurations regarding the number of control features that are exposed or granted access to and the number of control features that a user is denied access to.

FIG. 2 depicts an embodiment in which two control features 205 are exposed as well as indicators 210 which are also control features of computing device 215. Control features 205 and indicators 210 may be a button, a switch, a port, an indicator light, a MAC address display, a serial number display, and status indicators which are exposed by faceplate 105 and thus access is allowed to a general user to control features 205 and indicators 210. Such indicators may be LED lights or other lights which may indicate to a user information regarding the performance of the computing device 215. For example, computing device 215 may be a network switch and indicators 210 may show information regarding whether the network switch is powered on, is connected to a network, if wireless networking is active, how many devices it is networked to and other information displayed by network switches.

In one embodiment, faceplate 105 exposes and therefore allows access to displays which may be electronic or digital displays or fixed displays that do not change. Such displays may provide information regarding computing device 215 such as a model number, a password, a MAC address, a Network identification, etc. FIG. 2 also depicts faceplate 105 obscuring the view of and prohibiting access to control features of computing device 215. In one embodiment, faceplate 105 may deny, prohibit or limit access to a port, an Ethernet port, an indicator, a cable, a switch, a dongle and a button.

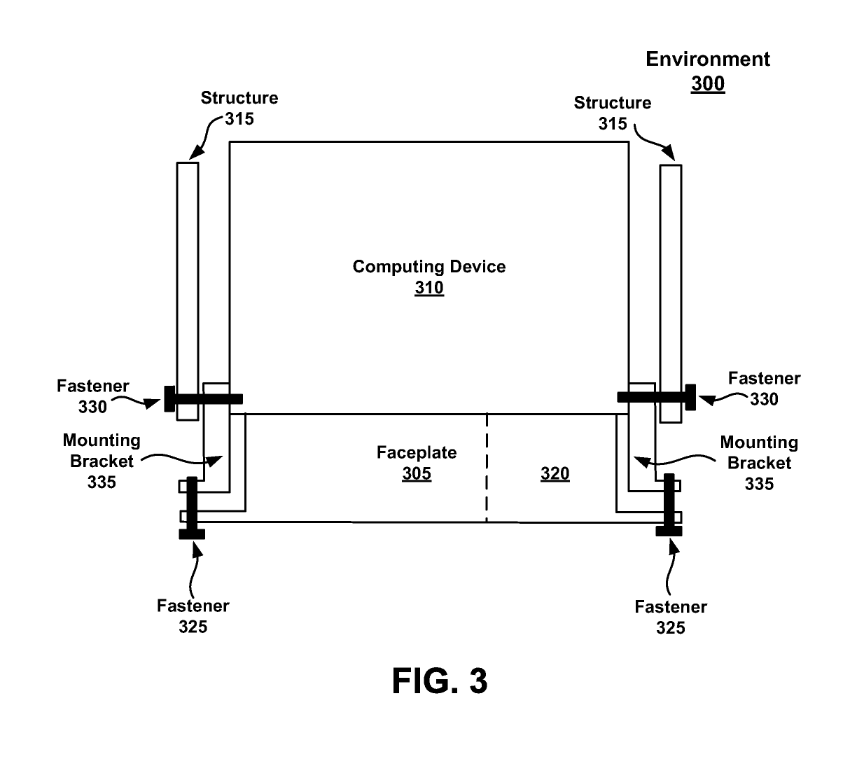

With reference now to FIG. 3, a block diagram of a cross-section top view of a computing device protector in accordance with embodiments of the present technology. Environment 300 includes faceplate 305, computing device 310, structure 315, enclosure 320, fasteners 325 and 330 and mounting brackets 335. Environment 300 should not be construed to limit the present technology.

It should be appreciated that faceplate 305 of FIG. 3 has all the same features and capabilities as those described for faceplate 105 of FIG. 1 and faceplate 105 of FIG. 2. It should be appreciated that computing device 310 has all the same features as those described for computing device 215. It should be appreciated that mounting brackets 335 have all the features as those described for mounting bracket 110.

For purposed of FIG. 3, the exposed surface of the computing device is the surface facing faceplate 305 which comprises control features of computing device 310. In one embodiment, the exposed surface is the front panel of a network switch. In one embodiment, faceplate 305 is in contact with computing device 310 as depicted in FIG. 3. In one embodiment, faceplate 305 does not directly contact computing device 310. In one embodiment, faceplate 305 is attached to two mounting brackets 335. One mounting bracket is at one end of the exposed surface of computing device 310 and the other mounting bracket is at the opposite end. In one embodiment, mounting brackets 335 attach to side surfaces of computing device 310 and not to the exposed surface of computing device 310. In one embodiment, mounting brackets 335 may attach to the exposed surface of computing device 310.

In one embodiment, faceplate 305 attaches to mounting brackets 335 using fasteners 325. It should be appreciated that fasteners 325 have all the features and abilities as those described for fastener 115.

In one embodiment, structure 315 is designed to hold computing device 310 in a fixed position. Structure 315, as depicted in FIG. 315 has two parts. The two parts may be connected by a section of structure 315 not depicted in FIG. 3, or structure 315 may be comprised of two or more parts. Structure 315 may be a standard rack or mount used in the art for mounting a computing device such as a network switch. Structure 315 may be a custom apparatus designed for a specific mounting purpose. In one embodiment, structure 315 is a standard rack mounting structure designed to mount a standard size 1U computing device. In one embodiment, structure 315 is placed in a public area and may expose only one surface of computing device 310. It should be appreciated that structure 315 may be attached to a wall, a desk, a ceiling, a bookshelf, a floor, a piece of furniture or another type of structure. In one embodiment, structure 315 is a piece of furniture such as a desk. Fasteners may be used to attach computing device 310 to structure 315 that are not depicted in FIG. 3.

In one embodiment, fasteners 330 are standard fasteners and are used to mount computing device 310 to structure 315. In one embodiment, mounting brackets 335 are placed between structure 315 and computing device 310 and fasteners 330 are inserted through structure 315, through mounting brackets 335 and into computing device 310. In one embodiment, fasteners 330 have the same abilities as fasteners 115.

In one embodiment, faceplate 305 is constructed in such a manner that is creates a space enclosed on all sides when fixed in a position relative to computing device 310. This is depicted using dotted line the dotted line to create enclosure 320. Enclosure 320 may be a variety of sizes and shapes. In one embodiment, enclosure 320 is employed to house hardware components connected or attached to computing device 310. For example, a cable or a dongle may be plugged into a port of computing device 310. If computing device 310 is in a public area, then a person may remove the dongle or cable and cause a disruption in the services provided by computing device 310. However, a computing device 310 that is used with faceplate 305 may prevent a user from removing the dongle or other hardware device by protecting the dongle in enclosure 320. In one embodiment, enclosure 320 has an opening to allow a cable to pass through into enclosure 320. In one embodiment, enclosure 320 is created using computing device 310, a mounting bracket, and a faceplate.

What is claimed:

1. A computing device protector, comprising:
a faceplate to limit access to an exposed surface of a computing device wherein said exposed surface of said computing device comprises control features and wherein said faceplate is configured limit access to only a portion of said control features and is configured to be positioned relative to said computing device such that said faceplate can be removed without requiring said computing device to be dismounted.

2. The computing device protector of claim 1, said faceplate further comprising:
an opening formed through said faceplate, said opening having dimensions which are sufficiently large to allow a cable to pass through said opening and sufficiently small such that a cable connector attached to an end of said cable cannot pass through said opening.

3. The computing device protector of claim 2, wherein said cable cannot be removed from said computing device when said faceplate is coupled to said computing device.

4. The computing device protector of claim 1, further comprising:
a mounting bracket configured to be mounted to said computing device and configured to receive said faceplate via a fastener wherein said fastener prevents unauthorized users from removing said faceplate.

5. The computing device protector of claim 4, where said fastener is selected from the group of fasteners consisting of: a screw, a lock requiring a key, a tamper-resistant-fastener, and a hinge.

6. The computing device protector of claim 4, wherein said faceplate is further configured to be removed without requiring said mounting bracket to be removed from said computing device.

7. The computing device protector of claim 1, further comprising:
two mounting brackets configured to be mounted on opposite surfaces of said computing device using standard mounting points on said computing device and configured to receive said faceplate via two fasteners.

8. The computing device protector of claim 1, where said faceplate is configured to limit access to a control feature of said computing device where said control feature is selected from the group of control features consisting of: a port, an Ethernet port, an small form factor pluggable port, an indicator, a cable, a switch, a dongle and a button.

9. The computing device protector of claim 1, where said faceplate is configured to not limit access to a control feature of said computing device where said control feature is selected from the group of control features consisting of: a port, an indicator light, a media access control address display, a serial number display, and a status indicator.

10. The computing device protector of claim 1, wherein said faceplate is configured to be compatible with more than one type of said computing device.

11. The computing device protector of claim 1, wherein said faceplate creates an enclosed area between said computing device and said faceplate for said control features of said computing device.

12. A computing device protector, comprising:
a faceplate having a front surface, said front surface configured to be disposed proximate to an exposed surface of a computing device wherein said computing device comprising control features; and
an opening formed through said faceplate, said opening having dimensions which are sufficiently large to allow a cable to pass through said opening and sufficiently small such that a cable connector attached to an end of said cable cannot pass through said opening, said faceplate configured to be removed without requiring said computing device to be dismounted.

13. A computing device protector, comprising:
a computing device configured to be mounted in a rack;
a mounting bracket configured to be mounted between said rack and said computing device via a fastener which passes through said rack and said mounting bracket into said computing device; and
a faceplate to limit access to an exposed surface of said computing device wherein said exposed surface of said computing device comprises control features and wherein said faceplate is configured limit access to only a portion of said control features and is configured to be mounted to said mounting bracket and positioned relative to said computing device such that said faceplate can be removed without requiring said computing device to be dismounted.

14. The computing device protector of claim 13, wherein said computing device and said rack are a standard size.

15. The computing device protector of claim 13, said faceplate further comprising:
an opening formed through said faceplate, said opening having dimensions which are sufficiently large to allow a cable to pass through said opening and sufficiently small such that a cable connector attached to an end of said cable cannot pass through said opening.
